(19) United States
(12) Patent Application Publication
(10) Pub. No.: US 2020/0117933 A1
(43) Pub. Date: Apr. 16, 2020

(54) LIGHT-EMITTING SIGNAL INTENSITY CONTROL METHOD AND ELECTRONIC DEVICE

(71) Applicant: Egis Technology Inc., Taipei (TW)

(72) Inventors: Chu-Hsin Chang, Taipei (TW); Chun-Ching Tseng, Taipei (TW); Kuan-Yi Lin, Taipei (TW)

(73) Assignee: Egis Technology Inc., Taipei (TW)

(21) Appl. No.: 16/592,788

(22) Filed: Oct. 4, 2019

Related U.S. Application Data
(60) Provisional application No. 62/744,201, filed on Oct. 11, 2018.
(60) Provisional application No. 62/863,270, filed on Jun. 19, 2019.

(30) Foreign Application Priority Data
Aug. 7, 2019 (CN) 201910724631.0

(51) Int. Cl. G06K 9/20; G06K 9/00

(52) U.S. Cl. CPC G06K 9/2027; G06K 9/0004

(57) ABSTRACT

Provided is a light-emitting intensity control method, which is suitable for an electronic device. The electronic device includes a processing component, a light-emitting component, and a sensing module. The light-emitting component includes a fingerprint sensing region. The sensing module is disposed below the fingerprint sensing region. The light-emitting intensity control method includes the following steps: controlling, by the processing component, the fingerprint sensing region of the light-emitting component to emit an optimized illumination beam to a finger above the fingerprint sensing region according to optimized data. The light intensity distribution of the optimized illumination beam is non-uniform. The fingerprint sensing region is divided at least into a first region and a second region from the center to the periphery. The light intensity of the first region is smaller than the light intensity of the second region. Besides, an electronic device is also proposed.

### CROSS-REFERENCE TO RELATED APPLICATION

This application claims the priority benefits of U.S. provisional application Ser. No. 62/744,201, filed on Oct. 11, 2018, U.S. provisional application Ser. No. 62/863,270, filed on Jun. 19, 2019, and China application serial no. 201910724631.0, filed on Aug. 7, 2019. The entirety of each of the above-mentioned patent applications is hereby incorporated by reference herein and made a part of this specification.

### BACKGROUND OF THE INVENTION

### 1. Field of the Invention

The present invention relates to a light-emitting signal intensity control method for a light-emitting component and an electronic device, and in particular, to a method capable of controlling a light-emitting signal intensity distribution of a light-emitting component to emit a non-uniform beam, and an electronic device thereof.

### 2. Description of Related Art

With the continuous evolution and improvement of electronic technology and manufacturing technology, electronic products have also been innovated. Electronic products such as computers, mobile phones, and cameras have become essential tools for modern people. Besides, in today's smart portable devices, fingerprint sensing devices need to be integrated to enhance the security of smart portable devices and support more smart functions.

Nowadays, a user can press a finger on a display of a mobile phone for fingerprint sensing. However, during the sensing process, the light intensity sensed by surrounding sensing pixels in a sensing module tends to be lower than the light intensity sensed by central sensing pixels in the sensing module, so that the light intensities obtained by the sensing module may differ, which may affects the accuracy of fingerprint sensing. So, in conventional solutions, backend software is used to correct the signal intensity. However, the conventional solution brings some side effects, such as loss of details caused by noise amplification. Therefore, how to sense the uniform light intensity is studied by those skilled in the art.

### SUMMARY OF THE INVENTION

The present invention provides a light-emitting signal intensity control method and an electronic device, which can uniformize the light intensity sensed by a sensing module, thereby obtaining good optical sensing image quality.

The present invention provides a light-emitting signal intensity control method, which is suitable for an electronic device. The electronic device includes a processing component, a light-emitting component, and a sensing module. The light-emitting component includes a fingerprint sensing region and a plurality of light-emitting pixels arranged in an array in the fingerprint sensing region. The sensing module is disposed below the fingerprint sensing region. The light-emitting signal intensity control method includes the following steps: controlling, by the processing component, the fingerprint sensing region of the light-emitting component to emit an optimized illumination beam to a finger above the fingerprint sensing region according to optimized data, the optimized illumination beam being reflected by the finger to reach the sensing module, thereby generating a fingerprint image. A light intensity distribution of the optimized illumination beam is non-uniform. The fingerprint sensing region is divided at least into a first region and a second region from the center to the periphery thereof. The light intensity emitted by the light-emitting pixels in the first region is smaller than the light intensity emitted by the light-emitting pixels in the second region.

The present invention further provides an electronic device for sensing a fingerprint image of a finger. The electronic device includes a light-emitting component, a processing component, and a sensing module. The light-emitting component includes a fingerprint sensing region and a plurality of light-emitting pixels arranged in an array in the fingerprint sensing region for providing an optimized illumination beam to the finger. The processing component is configured to control the light-emitting component according to optimized data. The sensing module is disposed below the fingerprint sensing region and configured to receive the optimized illumination beam that reaches the sensing module after being reflected by the finger, thereby generating the fingerprint image. A light intensity distribution of the optimized illumination beam is non-uniform. The fingerprint sensing region is divided at least into a first region and a second region from the center to the periphery thereof. The light intensity emitted by the light-emitting pixels in the first region is smaller than the light intensity emitted by the light-emitting pixels in the second region.

Based on the above, the light-emitting signal intensity control method and the electronic device of the present invention can provide an optimized illumination beam (non-uniform beam) to a finger during fingerprint sensing to uniformize a light intensity distribution sensed by a sensing module, thereby obtaining good optical sensing image quality.

In order to make the aforementioned and other objectives and advantages of the present invention comprehensible, embodiments accompanied with figures are described in detail below.

### BRIEF DESCRIPTION OF THE DRAWINGS

FIG. 1 is a flowchart showing steps of a light-emitting signal intensity control method according to an embodiment of the present invention.

FIG. 2 is a schematic diagram of an electronic device according to an embodiment of the present invention.

FIG. 3 is a diagram showing a light intensity distribution of an illumination beam emitted by a light-emitting component of the electronic device of FIG. 2.

FIG. 4 is a diagram showing a light intensity distribution of a reflected beam that is sensed by the electronic device of FIG. 2 and reflected by a finger.

FIG. 5 is a diagram showing a simulated illumination light intensity distribution of optimized data generated according to original data of FIG. 4.

FIG. 6 is a diagram showing a light intensity distribution of an optimized illumination beam emitted by the light-emitting component controlled according to the optimized data of FIG. 5.

FIG. 7 is a diagram showing a light intensity distribution of a reflected beam reflected by the finger and sensed by a sensing module after the optimized illumination beam of FIG. 6 illuminated to the finger.

FIG. 8 shows an actual light intensity distribution curve of a reflected beam sensed by a sensing module before and after a light-emitting component generates an illumination beam according to optimized data according to an embodiment.

FIG. 9 is a flowchart showing steps of a light-emitting signal intensity control method according to another embodiment of the present invention.

FIG. 10 is a diagram showing a light intensity distribution of an optimized illumination beam emitted by a light-emitting component according to an embodiment of the present invention.

FIG. 11A is a schematic diagram showing a light intensity distribution of a reflected beam sensed by a sensing module according to an embodiment.

FIG. 11B shows a distribution curve of an analog-to-digital conversion energy velocity corresponding to the light intensity distribution of the reflected beam of FIG. 11A with respect to sensing pixels at different coordinate positions.

FIG. 12 is a schematic diagram illustrating a fitting model according to an embodiment of the present invention.

FIG. 13A shows a distribution curve of the light-emitting signal intensity of light-emitting pixels of a fingerprint sensing region in a light-emitting component with respect to positions of the light-emitting pixels according to an embodiment.

FIG. 13B is a schematic diagram showing an optimized illumination beam generated according to the distribution curve in FIG. 13A.

### DESCRIPTION OF THE EMBODIMENTS

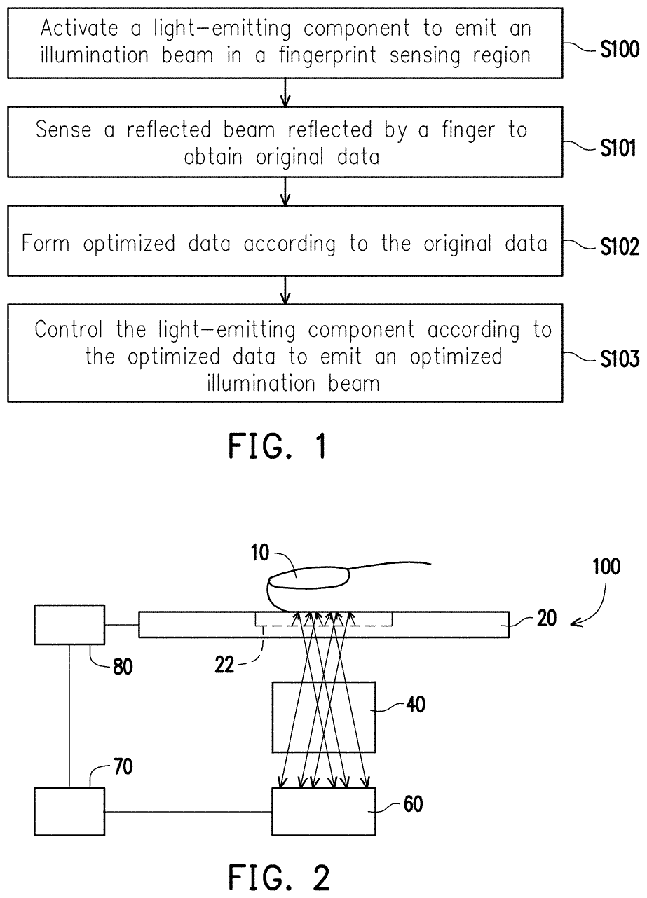

FIG. 1 is a flowchart showing steps of a light-emitting intensity control method according to an embodiment of the present invention. FIG. 2 is a schematic diagram of an electronic device according to an embodiment of the present invention. Refer to FIG. 1 and FIG. 2. An embodiment of the present invention provides a light-emitting intensity control method. The method is at least applicable to an electronic device 100 illustrated in FIG. 2, but the present invention is not limited thereto. The electronic device 100 includes a light-emitting component 20 and a sensing module 60. The light-emitting component 20 has a fingerprint sensing region 22. A user can put a finger 10 on the fingerprint sensing region 22 for fingerprint sensing. In the present embodiment, the electronic device 100 may further include an optical module 40.

In the present embodiment, the light-emitting component 20 is, for example, a display panel, a touch display panel, or a combination of the display panel or the touch display panel with a finger pressing plate. For example, the light-emitting component 20 is, for example, an organic light-emitting diode (OLED) display panel, but the present invention is not limited thereto. Alternatively, the light-emitting component 20 may be a touch display panel, such as an OLED display panel having a plurality of touch electrodes. The plurality of touch electrodes may be formed on an outer surface of the OLED display panel or embedded in the OLED display panel, and the plurality of touch electrodes may perform touch detection by self-capacitance or mutual capacitance. Or, the light-emitting component 20 may be a combination of a finger pressing plate and a display panel or a combination of a finger pressing plate and a touch display panel.

The optical module 40 is, for example, a lens group having a collimator structure and/or including a micro-lens layer and/or a pin-hole layer. In the present embodiment, the optical module 40 is, for example, a lens group including one or a combination of more optical lenses having a diopter, for example, including various combinations of non-planar lens such as a biconcave lens, a biconvex lens, a concavo-convex lens, a convexo-concave lens, a plano-convex lens, and a plano-concave lens. The present invention does not limit the type and category of the optical module 40. For example, the optical module 40 is composed of two lenses, but in other embodiments, it may be composed of three lenses or four lenses. The present invention is not limited thereto.

In the present embodiment, the sensing module 60 includes, for example, a plurality of sensing pixels. The plurality of sensing pixels is arranged in a sensing array. Each of the sensing pixels may include at least one photodiode. But the present invention is not limited thereto. When performing fingerprint sensing, the user puts the finger 10 close to or onto the fingerprint sensing region 22, and the light-emitting component 20 emits an illumination beam to illuminate the finger 10. After the illumination beam is reflected by the finger, the illumination beam is sequentially transmitted to pass through the light-emitting component 20 and the optical module 40 and eventually reach the sensing module 60 for fingerprint sensing.

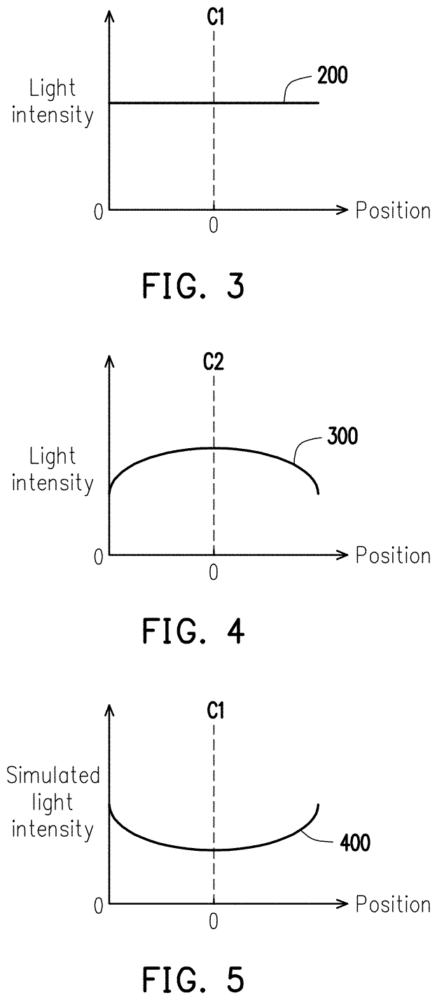

FIG. 3 is a diagram showing a light intensity distribution of an illumination beam emitted by a light-emitting component of the electronic device of FIG. 2. Refer to FIG. 1 to FIG. 3. In the present embodiment, when a user puts a finger onto the fingerprint sensing region 22 to perform fingerprint sensing, the electronic device 100 performs step S100 to activate the light-emitting component 20 to emit an illumination beam in the fingerprint sensing region 22. In detail, in the present embodiment, an identical voltage is applied to the plurality of light-emitting pixels which is located within the fingerprint sensing region 22. The plurality of light-emitting pixels is arranged in an array. Therefore, light intensities of the light emitted by the light-emitting pixels in the corresponding fingerprint sensing region 22 may be equal. In order to reduce the power consumption, during the fingerprint sensing, only the light-emitting pixels in the fingerprint sensing region 22 may emit light signals, but the present invention is not limited thereto. In the present embodiment, a light intensity distribution of the illumination beam emitted by the light-emitting pixels located within the fingerprint sensing region 22 may be a curve 200 as shown in FIG. 3. Specifically, the curve 200 represents the light intensity distribution of a plurality of light-emitting pixels (not shown) located at different positions in the fingerprint sensing region 22. A center line C1 crossing the curve 200 represents a central position of the fingerprint sensing region 22. As shown by the curve 200, regardless of the distance between the light-emitting pixel and the central position of the fingerprint sensing region 22, the light intensities are the same. That is, the light intensity distribution of the illumination beam is uniform.

FIG. 4 is a diagram showing a light intensity distribution of a reflected beam which is reflected by a finger and sensed by the electronic device of FIG. 2. Refer to FIG. 1 to FIG. 4, step S101 is performed to sense a reflected beam reflected by the finger 10 to obtain original data. Specifically, the original data is represents a light intensity distribution, of the reflected beam which is reflected by the finger 10, obtained by the sensing module 60 in the electronic device 100. if the curve 200 as shown in FIG. 3 is adopted to be the light intensity distribution of the fingerprint sensing region 22 of the light-emitting component 20, reflected light sensed by a plurality of sensing pixels in the sensing module 60 may have different light intensities. In the light intensity distribution of the reflected beam sensed by the sensing module 60, the closer a sensing pixel to a central position of the fingerprint sensing region, the larger light intensity sensed by the sensing pixel, and the farther the sensing pixel away from the central position of the fingerprint sensing region, the smaller light intensity sensed by the sensing pixel. Thus, a light intensity distribution sensing result of the reflected beam presenting an upwardly convex shape is generated. The curve 300 represents reflected light intensity values sensed by a plurality of sensing pixels (not shown) of the sensing module 60 at different positions in the sensing array. A center line C2 is a central position of the array formed by the sensing pixels.

FIG. 5 is a diagram showing a simulated illumination light intensity distribution of optimized data generated according to original data of FIG. 4. Refer to FIG. 1, FIG. 2, FIG. 4, and FIG. 5. Next, step S102 is performed to form optimized data (simulated illumination light intensity distribution) according to the original sensing data. In detail, in the present embodiment, a value of the original data measured above is reciprocated to form the optimized data. Therefore, in the optimized data, low light intensity of the original data will be adjusted to high light intensity, and the high light intensity will be adjusted to the low light intensity, thereby forming a diagram showing a simulated light intensity distribution presenting a downwardly-concave shape, namely, a curve 400 as shown in FIG. 5. That is, corresponding to the original data presenting an upwardly-convex shape (the light intensity distribution of the reflected beam, as shown by the curve 300), a simulated illumination light intensity distribution (optimized data) presenting a downwardly-concave shape is generated, as shown by the curve 400.

A value corresponding to the center line C1 is an illumination light intensity value after the adjustment of the light-emitting pixel located at the central position of the fingerprint sensing region 22. It is worth mentioning that when the electronic device 100 is manufactured, that is, before the electronic device 100 is delivered from the factory, the optimized data has been generated and built into the electronic device 100, for example, stored in a memory unit 70 as shown in FIG. 2, such that the electronic device 100 has optimized data after being completely manufactured (that is, before being delivered from the factory). That is, steps S100, S101, and S102 in FIG. 1 are performed before the electronic device 100 is delivered from the factory. Or, the optimized data may be generated upon the fingerprint sensing operation of the user after the electronic device 100 is delivered from the factory, and stored in the memory unit 70. Therefore, when the electronic device 100 performs fingerprint sensing, the processing component 80 may control the light-emitting intensity of the light-emitting component 20 according to the optimized data as electrical parameter data of the light-emitting pixels in the fingerprint sensing region 22 of the light-emitting component 20, for example, current or voltage values applied to the light-emitting pixels. The memory unit 70 will be described in detail in subsequent paragraphs.

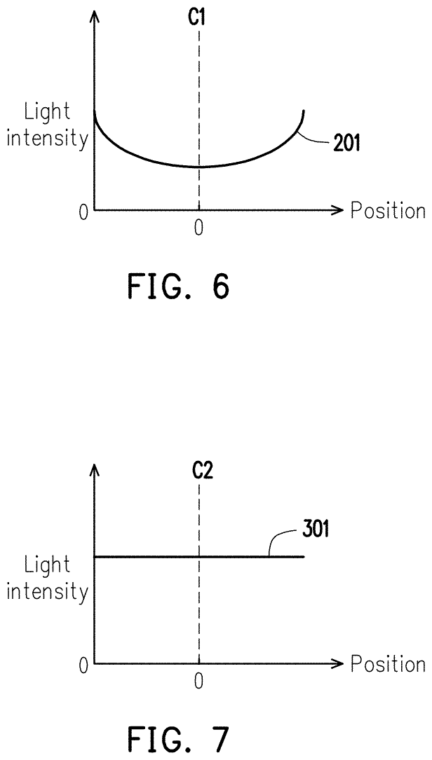

FIG. 6 is a diagram showing a light intensity distribution of an optimized illumination beam emitted by the light-emitting component controlled according to the optimized data of FIG. 5. Refer to FIG. 1, FIG. 2, FIG. 5, and FIG. 6. Next, step S103 is performed to control the light-emitting component 20 according to the optimized data to emit an optimized illumination beam. In detail, the electronic device 100 correspondingly controls electrical parameters of the plurality of light-emitting pixels in the fingerprint sensing region 22 of the light-emitting component 20 according to the optimized data, so that the emission light intensity emitted by the light-emitting pixels farther away from the central position of the fingerprint sensing region 22 is larger while the emission light intensity emitted by the light-emitting pixels closer to the central position of the fingerprint sensing region 22 is smaller. Thus, a non-uniform beam having an emission light intensity distribution presenting a downwardly-concave shape is generated, which is a curve 201 as shown in FIG. 6. A value corresponding to the center line C1 is an illumination light intensity value generated, according to the optimized data, by the light-emitting pixel located at the central position of the fingerprint sensing region 22. Specifically, in the present embodiment, the fingerprint sensing region 22 is divided at least into a first region and a second region from the center to the periphery thereof, and the light intensity emitted by the light-emitting pixels in the first region is smaller than the light intensity emitted by the light-emitting pixels in the second region.

FIG. 7 is a diagram showing a light intensity distribution of the reflected beam reflected by the finger and sensed by a sensing module 60 after the optimized illumination beam of FIG. 6 illuminated to the finger. Refer to FIG. 1, FIG. 2, FIG. 6, and FIG. 7. As shown by a curve 301 in FIG. 7, after the optimized illumination beam (non-uniform beam) is illuminated to the finger 10 and reflected by the finger, the light intensity distribution of the reflected beam sensed by the sensing module 60 will present a uniform distribution. A center line C2 represents a central position of a sensing array composed of sensing pixels. That is, the reflected light intensity value sensed by the sensing pixels located at the central position of the sensing array may be substantially the same as the reflected light intensity value sensed by the sensing pixels located at an edge position of the sensing array. That is, all of the sensing pixels in the sensing array, regardless of their positions, may sense the reflected light intensity values which are substantially the same.

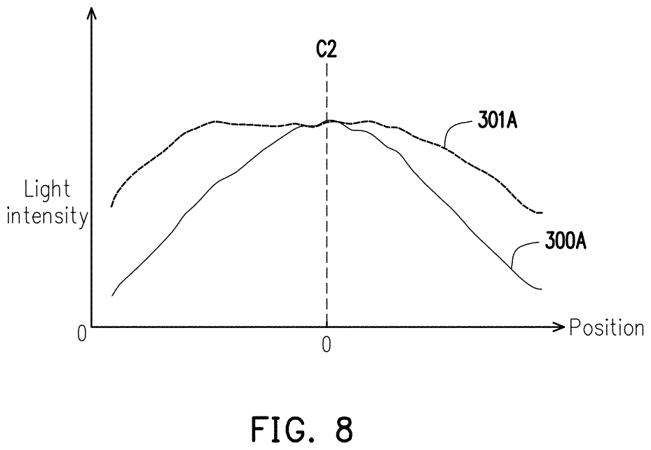

FIG. 8 shows an actual light intensity distribution curve of the reflected beam sensed by a sensing module before and after a light-emitting component generates an illumination beam according to optimized data according to an embodiment. Please refer to FIG. 2 and FIG. 8. A curve 300A shown in FIG. 8 represents a light intensity distribution of the reflected beam sensed by the sensing module 60 when the light-emitting component 20 does not generate an illumination beam according to the optimized data, that is, the light intensity distribution of the illumination beam is uniform (the curve 200 as shown in FIG. 3). A value corresponding to the center line C2 is a light intensity value sensed by a center point position of the sensing array. A curve 301A represents a light intensity distribution of the reflected beam sensed by the sensing module 60 when the light-emitting component 20 generates a non-uniform illumination beam according to the optimized data. As can be seen from the curves 300A and 301A shown in FIG. 8, compared with a uniform beam, the light intensity distribution sensed by the sensing module 60 after an optimized illumination beam (non-uniform beam) emitted by the light-emitting component 20 is illuminated to the finger 10 and then reflected is relatively uniform. Therefore, the present invention can improve the light intensity distribution of the reflected beam sensed by the sensing module 60 to be relatively uniform, thereby obtaining a good optical sensing image.

It is worth mentioning that in the present embodiment, the electronic device 100 may be a handheld electronic device, such as a smart phone, a tablet or other handheld electronic devices. Therefore, the aforementioned light-emitting intensity control method for the light-emitting component 20 may be implemented in a built-in or mounted software application. Specifically, in the present embodiment, the electronic device 100 may further include a memory unit 70 and a processing component 80, and the aforementioned light-emitting intensity control method for the light-emitting component 20 may be built into the memory unit 70 in the handheld electronic device in the form of software. Instructions may be presented in a manual or automatic software processing manner, allowing the processing component 80 to further perform control and adjustment. The processing component 80 is, for example, a central processing unit (CPU), a microprocessor, a digital signal processor (DSP), a programmable controller, a programmable logic device (PLD) or other similar devices or combinations of these devices, which will not be limited in the present invention.

In an embodiment, the light-emitting intensity control method may also build or store the optimized data into a storage unit in the handheld electronic device. When fingerprint sensing is performed, the electronic device 100 of the present embodiment may control the light-emitting component 20 to provide an optimized illumination beam according to the stored optimized data. In this way, the processing operation time required for the handheld electronic device to perform fingerprint sensing can be reduced.

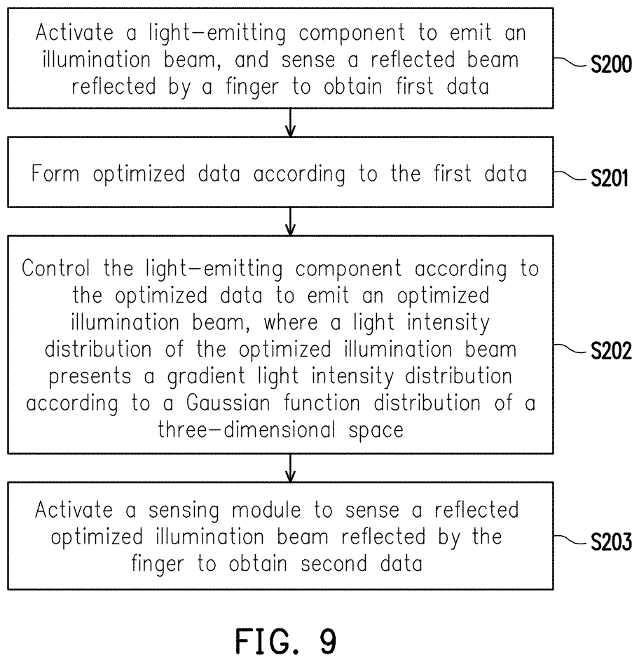

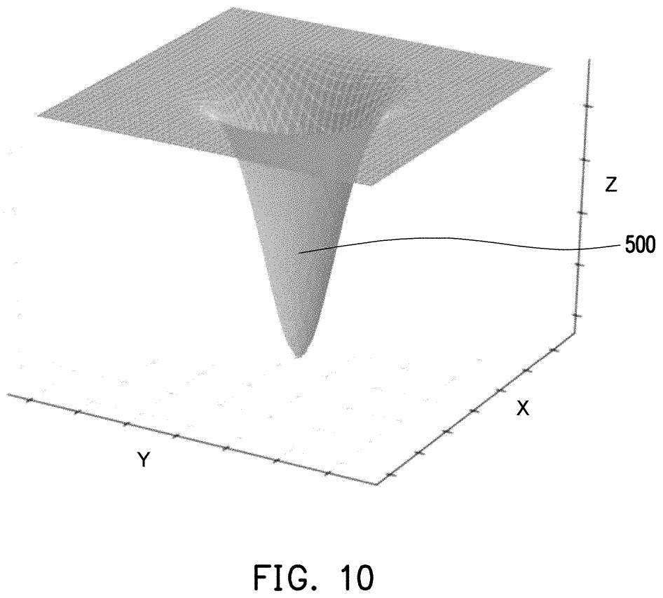

FIG. 9 is a flowchart showing steps of a light-emitting intensity control method according to another embodiment of the present invention. FIG. 10 is a diagram showing a light intensity distribution of an optimized illumination beam emitted by a light-emitting component according to an embodiment of the present invention. Please refer to FIG. 2, FIG. 9, and FIG. 10. The light-emitting intensity control method provided by FIG. 9 and FIG. 10 and the light intensity distribution of the optimized illumination beam are applicable to at least the electronic device 100 illustrated in FIG. 2, but the present invention is not limited thereto. In the light-emitting intensity control method of the present embodiment, step S200 is first performed to activate the light-emitting component 20 to emit an illumination beam, and to sense a reflected beam reflected by the finger 10 to obtain first data. The first data is the original data of the foregoing embodiment, which is a sensing result of the sensing module 60, that is, light intensity distribution data of the reflected beam.

Next, step S201 is performed to form optimized data according to the first data. Next, step S202 is performed to control the light-emitting component 20 according to the optimized data to emit an optimized illumination beam, where the light intensity distribution of the optimized illumination beam presents a gradient light intensity distribution according to a Gaussian function distribution of a three-dimensional space, which is a Gaussian function distribution curved surface 500 as shown in FIG. 10. Plane coordinates below the curved surface 500 (a plane formed by an X axis and a Y axis) are coordinate positions corresponding to the fingerprint sensing region 22. Values in a vertical direction (Z axis) represent the light intensity. For example, if the value of the curved surface 500 on the Z axis is lower, it indicates that the light intensity of the optimized illumination beam emitted by the light-emitting pixels at the corresponding XY coordinate positions in the fingerprint sensing region 22 is lower. If the value of the curved surface 500 on the Z axis is higher, the light intensity of the optimized illumination beam emitted by the light-emitting pixels at the corresponding XY coordinate positions in the fingerprint sensing region 22 is higher. Next, step S203 is performed to activate the sensing module 60 to sense a reflected optimized illumination beam reflected by the finger 10 to obtain second data.

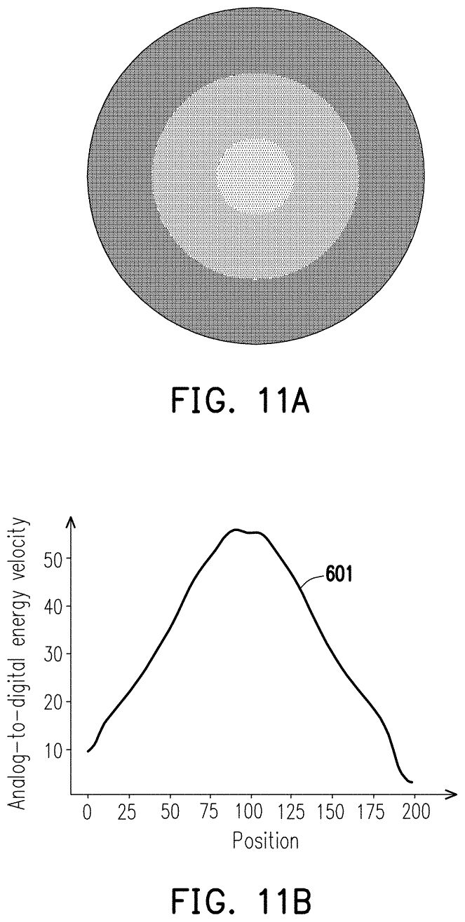

FIG. 11A is a schematic diagram showing a light intensity distribution of the reflected beam sensed by a sensing module according to an embodiment. FIG. 11B shows a distribution curve of an analog-to-digital conversion energy velocity corresponding to the light intensity distribution of the reflected beam of FIG. 11A with respect to sensing pixels at different coordinate positions. Please refer to FIG. 2, FIG. 11A, and FIG. 11B. In the aforementioned step of generating optimized data according to the original sensing data, it may further be carried out in the embodiment described below. In the present embodiment, first, the processing component 80 activates the light-emitting component 20 to emit an illumination beam. A light intensity distribution of the illumination beam is uniform. Next, the sensing module 60 senses a reflected beam reflected by the finger 10 to obtain original data. The sensing module 60 includes a plurality of sensing pixels arranged in a sensing array. Next, the aforementioned two steps are repeated to generate a plurality of original data corresponding to different light-emitting signal intensities (that is, the light intensity distribution of the reflected beam sensed by the sensing module 60, as shown in FIG. 11A). That is, in the case that the illumination beam is uniform, different light-emitting signal intensities are adjusted to generate a plurality of original data to generate a plurality of distribution curves of a plurality of analog-to-digital conversion (ADC) energy velocities with respect to the sensing pixels at different coordinate positions, which are a curve 601 as shown in FIG. 11B. In FIG. 11A, the display of the light intensity distribution of the reflected beam is expressed in a gray scale manner. A brightly-displayed gray scale color (i.e., a lighter color) represents that the sensed reflected light intensity is higher. A darkly-displayed gray scale color (i.e., a darker color) represents that the sensed light intensity is lower. Next, a fitting model is established according to the plurality of distribution curves.

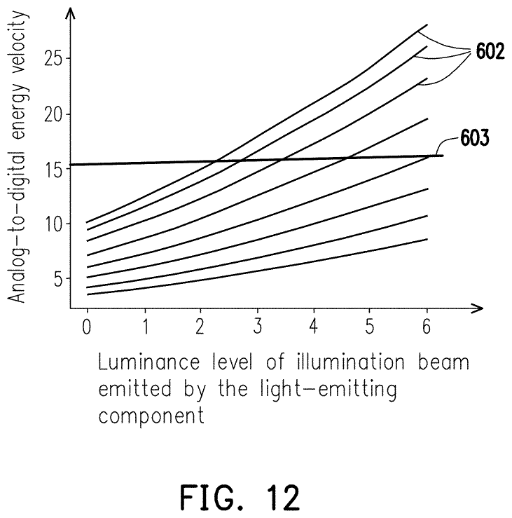

FIG. 12 is a schematic diagram illustrating a fitting model according to an embodiment of the present invention. Please refer to FIG. 2 and FIG. 12. The plurality of curves 602 in the fitting model of FIG. 12 are sensing pixels respectively corresponding to different coordinate positions in the sensing module. That is, each curve 602 is an ADC energy velocity of a particular sensing pixel at different light-emitting signal intensities. In detail, in the present embodiment, the fitting model is shown as a graph of a right angle coordinate relationship. As shown in FIG. 12, the Y coordinate represents the ADC energy velocity, and the X coordinate represents the level of luminance of the illumination beam emitted by the light-emitting component 20.

Therefore, in order to uniformize the reflected light intensity sensed by the sensing module, the embodiment of the present invention may set a suitable ADC energy velocity, such as a value of 15 on the Y axis. The level of luminance of the illumination beam corresponding to the sensing pixels at different coordinate positions in the sensing module may be obtained. In other words, in the method of obtaining optimized data (i.e., luminance distribution of the illumination beam) according to the fitting model, a sensing target value (i.e., ADC energy velocity) may be provided. The fitting model is utilized to calculate, according to the sensing target value, light-emitting signal intensities of a plurality of light-emitting pixels at different positions in the fingerprint sensing region 22 to generate optimized data (i.e., illumination light intensity distribution).

For example, in the present embodiment, the sensing target value may be set to 15 (a line segment 603 as shown in FIG. 12). The fitting model may be utilized to calculate the level of luminance required for each light-emitting pixel at different positions, which may be luminance level values corresponding to intersections of the plurality of different curves 602 and the line segment 603 as shown in FIG. 12 respectively. In the present embodiment, the curve 602 is a first-order nonlinear relation curve, but the present invention is not limited thereto. In another embodiment, the plurality of different curves 602 may also be formed as oblique lines by a linear regression function, but the present invention is not limited thereto.

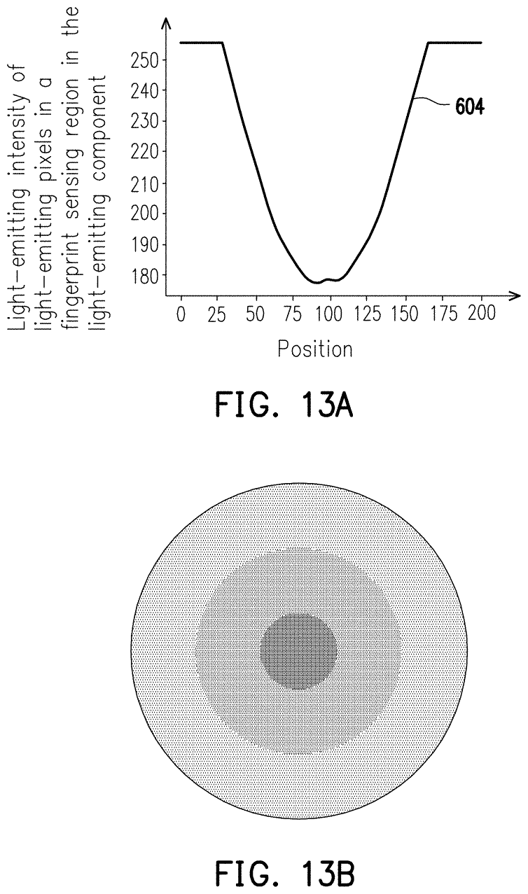

FIG. 13A shows a distribution curve of the light-emitting intensity of light-emitting pixels of a fingerprint sensing region 22 in a light-emitting component with respect to positions of the light-emitting pixels according to an embodiment. FIG. 13B is a schematic diagram showing an optimized illumination beam generated according to the distribution curve in FIG. 13A. Please refer to FIG. 2, FIG. 13A, and FIG. 13B. As described above, the present embodiment calculates the level of luminance (i.e., light-emitting intensity) required for each light-emitting pixel at different positions in the fingerprint sensing region 22 to form optimized data, which is a curve 604 as shown in FIG. 13A. The curve shows a distribution curve of the light-emitting intensity of a light-emitting pixel with respect to the position of the light-emitting pixel. As described above, the optimized data may be built into the memory unit 70 before the electronic device 100 is delivered from the factory.

Thereafter, that is, after the electronic device 100 is delivered from the factory, when a user performs fingerprint sensing using the electronic device, the electronic device 100 of the present invention controls the light-emitting component 20 according to the optimized data to emit an optimized illumination beam to a finger. A pattern of the optimized illumination beam is as shown in FIG. 13B. In FIG. 13B, the luminance distribution of the optimized illumination beam (non-uniform beam) is expressed in a gray scale manner. A lighter gray scale color represents that the light intensity is higher (brighter). A darker gray scale color represents that the light intensity is lower (darker). In this way, the light intensity sensed by the sensing module can be uniformized, thereby obtaining a good optical sensing image. As shown in FIG. 13A and FIG. 13B, in the present embodiment, the fingerprint sensing region 22 is divided at least into a plurality of regions from the center to the periphery thereof. The light intensity emitted by light-emitting pixels in the regions closer to the center of the fingerprint sensing region 22 is smaller than the light intensity emitted by light-emitting pixels in the regions farther away from the center of the fingerprint sensing region 22.

Based on the above, the light-emitting intensity control method for a light-emitting component and the electronic device of the present invention can provide an optimized illumination beam (non-uniform beam) to a finger during fingerprint sensing to uniformize a light intensity distribution sensed by a sensing module, thereby obtaining good optical sensing image quality.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. A light-emitting intensity control method, suitable for an electronic device, the electronic device comprising a processing component, a light-emitting component, and a sensing module, the light-emitting component comprising a fingerprint sensing region and a plurality of light-emitting pixels arranged in an array in the fingerprint sensing region, the sensing module being disposed below the fingerprint sensing region, the light-emitting intensity control method comprising:
controlling, by the processing component, the fingerprint sensing region of the light-emitting component to emit an optimized illumination beam to a finger above the fingerprint sensing region according to optimized data, the optimized illumination beam being reflected by the finger to reach the sensing module, thereby generating a fingerprint image, wherein a light intensity distribution of the optimized illumination beam is non-uniform,
wherein the fingerprint sensing region is divided at least into a first region and a second region from a center to a periphery thereof, and the light intensity emitted by the light-emitting pixels in the first region is smaller than the light intensity emitted by the light-emitting pixels in the second region.

2. The light-emitting intensity control method according to claim 1, further comprising:
activating, by the processing component, the light-emitting component to emit an illumination beam, the light intensity distribution of the illumination beam being uniform;
sensing, by the sensing module, a reflected beam reflected by the finger to obtain original data; and
forming, by the processing component, the optimized data according to the original data.

3. The light-emitting intensity control method according to claim 2, wherein the method of activating the light-emitting component to emit the illumination beam comprises:
applying an identical voltage to the light-emitting pixels in the fingerprint sensing region of the light-emitting component.

4. The light-emitting intensity control method according to claim 2, wherein the original data is a light intensity distribution of the reflected beam obtained by sensing the reflected beam reflected by the finger, wherein in the light intensity distribution of the reflected beam sensed by the sensing module, the closer a location to a central position of the fingerprint sensing region, the larger light intensity of the location, and the farther the location away from the central position of the fingerprint sensing region, the smaller light intensity of the location.

5. The light-emitting intensity control method according to claim 2, wherein the method of forming the optimized data according to the original data comprises:
reciprocating a value of the original data to form the optimized data.

6. The light-emitting intensity control method according to claim 1, further comprising:
activating, by the processing component, the light-emitting component to emit an illumination beam, the light intensity distribution of the illumination beam being uniform;
sensing, by the sensing module, a reflected beam reflected by the finger to obtain original data, the sensing module comprising a plurality of sensing pixels arranged in a sensing array; and
repeating the aforementioned two steps to generate a plurality of original data corresponding to different light-emitting signal intensities, and generating a plurality of distribution curves of a plurality of analog-to-digital energy velocities with respect to the sensing pixels at different coordinate positions in the sensing array;
establishing a fitting model according to the distribution curves;
providing a sensing target value; and
calculating, by using the fitting model, the light-emitting signal intensities of the light-emitting pixels at different positions in the fingerprint sensing region according to the sensing target value to generate the optimized data.

7. The light-emitting intensity control method according to claim 1, wherein the method of controlling, by the processing component, the light-emitting component according to the optimized data to emit the optimized illumination beam comprises:
correspondingly adjusting, by the processing component, electrical parameters of the light-emitting pixels in the fingerprint sensing region of the light-emitting component according to the optimized data.

8. The light-emitting intensity control method according to claim 1, wherein the light intensity distribution of the optimized illumination beam is according to a Gaussian function distribution of a three-dimensional space, and in the light intensity distribution of the optimized illumination beam, the farther a location away from the central position of the fingerprint sensing region, light intensity of the location is larger.

9. An electronic device for sensing a fingerprint image of a finger, comprising:
a light-emitting component, comprising a fingerprint sensing region and a plurality of light-emitting pixels arranged in an array in the fingerprint sensing region for providing an optimized illumination beam to the finger;
a processing component, configured to control the light-emitting component according to optimized data; and
a sensing module, disposed below the fingerprint sensing region and configured to receive the optimized illumination beam that reaches the sensing module after being reflected by the finger, thereby generating the fingerprint image, a light intensity distribution of the optimized illumination beam being non-uniform,
wherein the fingerprint sensing region is divided at least into a first region and a second region from a center to a periphery thereof, and the light intensity emitted by the light-emitting pixels in the first region is smaller than the light intensity emitted by the light-emitting pixels in the second region.

10. The electronic device according to claim 9, wherein the light-emitting component is activated by the processing component to emit an illumination beam, the sensing module is configured to sense a reflected beam reflected by the finger to obtain original data, and the optimized data is formed according to the original data.

11. The electronic device according to claim 10, wherein the light-emitting pixels in the fingerprint sensing region of the light-emitting component are applied with a same voltage to emit the illumination beam.

12. The electronic device according to claim 10, wherein the original data is light intensity distribution data of the reflected beam obtained by sensing, by the sensing module, the reflected beam reflected by the finger, wherein in the light intensity distribution of the reflected beam sensed by the sensing module, the closer a location to a central position of the fingerprint sensing region, the larger light intensity of the location, and the farther the location away from the central position of the fingerprint sensing region, the smaller light intensity of the location.

13. The electronic device according to claim 10, wherein the optimized data is formed by reciprocating a value of the original data.

14. The electronic device according to claim 11, wherein the processing component activates the light-emitting component to emit an illumination beam, the light intensity distribution of the illumination beam being uniform; the sensing module senses a reflected beam reflected by the finger to obtain original data, the sensing module comprising a plurality of sensing pixels arranged in a sensing array, a plurality of original data being generated in correspondence to illumination beams of different light-emitting signal intensities; and a plurality of distribution curves of a plurality of analog-to-digital energy velocities with respect to the sensing pixels at different coordinate positions in the sensing array is generated according to the plurality of original data, the distribution curves establish a fitting model, and the fitting model is utilized to calculate, according to a sensing target value, the light-emitting signal intensities of the light-emitting pixels at different positions in the fingerprint sensing region to generate the optimized data.

15. The electronic device according to claim 10, wherein the optimized illumination beam is obtained by correspondingly adjusting electrical parameters of the light-emitting pixels in the fingerprint sensing region of the light-emitting component according to the optimized data.

16. The electronic device according to claim 9, wherein the light intensity distribution of the optimized illumination beam is according to a Gaussian function distribution of a three-dimensional space, and in the light intensity distribution of the optimized illumination beam, the farther a location away from the central position of the fingerprint sensing region, light intensity of the location is larger.
